(19) United States
(12) Patent Application Publication
(10) Pub. No.: US 2008/0190006 A1
(43) Pub. Date: Aug. 14, 2008

(54) Pin Punch Tool for Firearms

(76) Inventor: Phillip J. Jenkins, Riverbank, CA (US)

Correspondence Address: MICHAEL I KROLL, 171 STILLWELL LANE, SYOSSET, NY, 11791, US

(21) Appl. No.: 11/673,503

(22) Filed: Feb. 9, 2007

(51) Int. Cl. B25B 27/08; F41C 27/00

(52) U.S. Cl. 42/90

(57) ABSTRACT

A pin punch having an ergonomic T-shaped handle which improves the user's comfort and controllable use of the device and reduces user fatigue. The pin punch is used to remove housing pins to field strip a firearm. Some firearms require moving a part while pushing on a particular pin until you feel the pin move past a detent.

### BACKGROUND OF THE INVENTION

1. Field of the Invention

The present invention relates generally to pin punch tools and, more specifically, to a pin punch for the removal of pistol or gun housing pins having an ergonomic T-shaped handle which improves the users comfort and controllable use of the device and reduces user fatigue. The pin punch is used to remove housing pins to field strip a firearm. Some firearms require moving a part while pushing on a particular pin until you feel the pin move past a detent. The punch is pushed with one hand and a fire arm part is moved with the other hand, to free up the pin, or in other cases, hold the fire arm with one hand and push with the punch tool with the other hand.

2. Description of the Prior Art

There are other pin punch tools designed for similar purposes. Typical of these is U.S. Pat. No. 100,686 issued to Stamp on 6 Mar. 1870

Another patent was issued to Lovett on 3 Sep. 1878 as U.S. Pat. No. 207,667. Another patent was issued to Kellemen on 1 Jan. 1924 as U.S. Pat. No. 1,479,506. Yet another U.S. Pat. No. 1,552,994 was issued to Lindeman on 8 Sep. 1925 and still yet another was issued on 3 Jan. 1956 to Farandatos as U.S. Pat. No. 2,729,124.

Another patent was issued to Etal on 28 Sep. 1965 as U.S. Pat. No. 3,208,302. Still another patent was issued to Butch on 5 Oct. 1971 as U.S. Pat. No. 3,609,790. Yet another U.S. Pat. No. 4,541,314 was issued to Korkowski on 17 Sep. 1985. Another was issued to Ballone et al. on 18 Dec. 1984 as U.S. Pat. No. 4,488,460 and still yet another was issued on 13 Feb. 1990 to Wheeler as U.S. Pat. No. 4,899,415.

Another was issued to Wasserbaech on 12 Oct. 1993 as U.S. Pat. No. 5,251,404. And still yet another was issued on 10 Aug. 1999 to Hayes Sr. as U.S. Pat. No. 5,934,000. Another patent was issued to Sudheimer on 12 Oct. 1999 as U.S. Pat. No. 5,964,451 and still another was issued on 14 Nov. 2000 to Emerson et al. as U.S. Pat. No. 6,145,235. Yet another U.S. Pat. No. 7,020,994 was issued to Buie on 4 Apr. 2006.

### U.S. Pat. No. 100,686

### Inventor: John Mitchell Stamp

### Issued: 8 Mar. 1870

A punch united with the awl and belt hook in one instrument, in the manner and for the purpose set forth.

### U.S. Pat. No. 207,667

### Inventor: James Lovett

### Issued: 3 Sep. 1878

The combination for operating a cutting shaft of augers, of two ratchet wheels, fixed on the axis, with a double faced detent or detent wheel, fixed on the arm between the two said wheels, which wheel engages with either the upper or lower ratchet wheel, as desired for either driving or removing the cutting shaft, substantially as shown, and for the purpose specified.

### U.S. Pat. No. 1,479,506

### Inventor: Henry Kellemen

### Issued: 1 Jan. 1924

A tool comprising a shank, having a block thereon forming a shoulder surrounding the shank, said block being rectangular in cross section and having tapered external bearing surfaces, said shank extending beyond said block, and a handle having a socket to receive said shank, the end of said handle engaging said block and limiting the movement of said shank into said socket.

### U.S. Pat. No. 1,552,994

### Inventor: Teddy Lindeman

### Issued: 8 Sep. 1925

An oiling and cleaning device for guns comprising a rod having a longitudinal bore therein opening to the atmosphere at one end of the rod, means for supplying oil to the bore in said rod, said rod being constructed of a series of sections detachably connected together, an means at the connecting portions of the sections for closing the bore therein.

### U.S. Pat. No. 2,729,124

### Inventor: Denis Farandatos

### Issued: 3 Jan. 1956

A cork extractor a tubular cork penetrating means, a hollow hand grip rigidly attached thereto, the total size of said grip being approximately the size of a gripping hand, said grip and said means being at right angles to each other, and cylindrical gas pressure generating means housed in the grip and opening into said penetrating means.

### U.S. Pat. No. 3,208,302

### Inventor: Karl Lewis Etal

### Issued: 28 Sep. 1965

A cleaning rod for fire arms comprising a body member, a handle secured to said body member and rotatable with said body member as a unit, a rod rotatably mounted on said body member, locking means releasably securing said rod to said body member and means mounted on said handle cooperatively engaging said locking means for releasing locking means, said handle remaining secure to said body member and said handle

### U.S. Pat. No. 3,609,790

### Inventor: Frank Butch

### Issued: 5 Oct. 1971

A gun cleaner for alternately cleaning rifled and unrifled barrels of different lengths and bores. The invention concerns a manually power driven screwdriver, awl, nut driver or the like having a handle shaped and dimensioned on its external circumferential surface to be mated with and driven by a conventional female ratchet or socket. Great torque and axial pressure may be applied via the power driven tool, facilitating the removal of frozen bolts, nuts, screws, etc.

### U.S. Pat. No. 4,541,314

### Inventor: Richard Korkowski

### Issued: 17, September

The invention concerns a manually power driven screwdriver, awl, nut driver or the like having a handle shaped and dimensioned on its external circumferential surface to be mated with and driven by a conventional female ratchet or socket. Great torque and axial pressure may be applied via the power driven tool, facilitating the removal of frozen bolts, nuts, screws, etc.

### U.S. Pat. No. 4,488,460

### Inventor: Michael Ballone et al.

### Issued: 18 Dec. 1984

An improved ergonomic handle for a hand tool or other implement has a substantially elliptical cross-section taken in a first plane which forms a dihedral angle of approximately thirty (30) degrees with respect to a second plane which is normal to the longitudinal axis of the shank of the tool. The length of the minor axis of the elliptical cross-section is approximately sixty percent (60%) of the length of the major axis. The longitudinal axis of the shank passes through the elliptical cross-section and through the line formed by the intersection of the first and second planes. The handle is formed substantially as a revolution of the elliptical cross-section about its major axis. As a result, the handle is well balanced and accommodates a variety of hand grips for various uses or orientations of the tool, and the handle is convenient and comfortable for substantially reducing operator fatigue over extended use of the tool. This is especially advantageous in connection with a hand ratchet tool.

### U.S. Pat. No. 4,899,415

### Inventor: Raymond Wheeler

### Issued: 13 Feb. 1990

A multipurpose handle for a gun cleaning kit has a coaxially aligned bore in one end of a cylindrical member and a perpendicular bore centrally of the member for selective threaded engagement with a cleaning rod section, to serve as either a “push” handle or a “pull” handle for the rod. The other end of the member has a coaxially aligned hexagonal socket opening with a magnet at the bottom for holding and driving a matching hexagonal screwdriver bit. Another perpendicular bore located between the end bore and the central bore of the handle permits the rod section to be slid through the handle for increasing the torque applied to the screwdriver bit. The exterior of the handle is knurled for better gripping.

### U.S. Pat. No. 5,251,404

### Inventor: Eberhard Wasserbaech

### Issued: 12 Oct. 1993

A belt grinder has a plurality of belts for simultaneously grinding the pins of a crankshaft during crankshaft rotation about its main bearing axis. A shoe for each belt urges the belt against the pin. A profile mechanism including a CNC controller and a servomotor controls each belt by moving the belt against the pin (via the shoe) in a motion for generating a cylindrical pin surface. Guide wheels which guide the belt to and from the shoe are mechanically coupled to the shoe for movement therewith to compensate for the effect of shoe movement on the belt path. A tension wheel maintains a desired tension on the belt and assists the guide wheels in maintaining a constant belt path length. Alternatively, a bias arrangement including an air cylinder applies tension to the belt via the guide wheel. The guide wheel may be retracted by an air cylinder to remove tension for belt removal and replacement.

### U.S. Pat. No. 5,934,000

### Inventor: Robert Hayes Sr.

### Issued: 10 Aug. 1999

A gun barrel cleaner is described for cleaning the bore of a pistol, rifle, or shotgun without danger of contaminating the breech area of the firearm. A cleaning rod is inserted from the nozzle of the gun extending into the breech area. Various structures are described for pivotal quick connection of interchangeable cleaning articles, such as brushes and oil swabs, to the end of the cleaning rod within the breech area. The cleaning article is pivoted into the breech area of the gun, and the rod pulled through the bore of the gun via the nozzle of the gun, preventing debris and/or oil contamination of the breech area of the gun. The procedure is then repeated as necessary utilizing different interchangeable cleaning articles as required. When clean, the cleaning article is replaced with a locking pin-locking tube combination secured by a padlock at the breech area of the gun with the cleaning rod in place within the barrel of the gun, visibly rendering accidental loading and discharge of the weapon impossible.

### U.S. Pat. No. 5,964,451

### Inventor: Louis Sudheimer

### Issued: 12 Oct. 1999

A weed removal tool is provided with an ergonomic handle shape which improves user comfort and reduces user fatigue and risk of injury. The handle is provided with a compound gripping surface which has been engineered and shaped to form a flattened egg-elliptical profile when viewed from the side, and a generally widened egg-shaped profile when viewed from the top or bottom. A strong, non-root cutting or severing, engineered shank is provided for gently loosening surrounding soil for removal of weed roots and is provided with a blunted tip for penetrating the soil without severing underlying roots. The shank is carefully engineered, shaped and proportioned to automatically relocate its operating fulcrum point so as to target, create, maximize and concentrate its soil and root loosening and lifting actions directly within the selected plants root system. The handle is provided with a recess which is shaped complementarily to the shank and adapted to receive the shank therein, if made in separate parts or materials.

### U.S. Pat. No. 6,145,235

### Inventor: Ashley Emerson et al.

### Issued: 14 Nov. 2000

An improved ramrod having utility in preparing a firearm for firing, said firearm being of the type that uses black powder as a propellant and is sometimes called a muzzleloader. The ramrod has an elongated body of substantial rigidity so that it may function to tamp a bullet prior to igniting a charge of black powder. A folding arm is permanently attached to and carried by the “outer” end of the elongated body. The folding arm has a stowed position in which the arm is generally aligned with the body's longitudinal axis. The arm also has a working position in which it makes a substantial angle (e.g., 90 degrees) with respect to the body's longitudinal axis. The attachment of the folding arm to the elongated body is by a pivot pin having an axis of rotation that is perpendicular to the body's longitudinal axis. A force may be transferred to the body by manually applying said force to the arm while the arm is in its working position. The permanent attachment of the arm to the elongated body ensures that the arm cannot become separated from the elongated body and lost. A transverse bore is preferably provided in each accessory, so that it may be tightened or loosened with respect to the elongated body. When an accessory has a protruding stud with a diameter that is essentially the same size as the transverse bore, then the stud on one accessory can be used to install or remove another accessory.

### U.S. Pat. No. 7,020,994

### Inventor: James Buie

### Issued: 4 Apr. 2006

A universal gun cleaning kit includes a universal handle including a female threaded opening of a first select size. A plurality of elongate rods have different outer diameters. Each rod has opposite near and distal ends. The distal ends are adapted for selectively receiving a gun barrel cleaning element. A plurality of shafts are each rotatably connected to an associated one of the rods. The shafts include a male threaded end of the first select size or a second select size. An adaptor has a female threaded end of the second select size and a male threaded end of the first select size. The shafts of the first select size can be directly threaded into the universal handle and the shafts of the second select size can be threaded into the universal handle using the adaptor so that, in use, a select one of the rods is rotatable relative to the universal handle.

While these devices may be suitable for the purposes for which they were designed, they would not be as suitable for the purposes of the present invention, as hereinafter described. The present invention provides a pin punch having an ergonomic t-shaped handle which improves the users comfort and controllable use of the device and reduces user fatigue. The pin punch is used to remove housing pins to field strip a firearm. Some firearms require moving a part while pushing on a particular pin until you feel the pin move past a detent.

### SUMMARY OF THE PRESENT INVENTION

A primary object of the present invention is to provide a pin punch for fire arms having an ergonomic T-shaped handle which improves the users comfort.

Another object of the present invention is to provide a pin punch for fire arms having an ergonomic T-shaped handle which improves the user's controllable use of the device.

Yet another object of the present invention is to provide a pin punch for fire arms having an ergonomic T-shaped handle which reduces user fatigue.

Still yet another object of the present invention is to provide a punch pin for the removal of fire arm housing pins.

Another object of the present invention is to provide a punch pin having a T shaped handle and tapered pin punch tool.

Yet another object of the present invention is to provide a pin punch tool for fire arms that is pushed with one hand and a fire arm part is moved with the other hand to free up the pin.

Still yet another object of the present invention is to provide a pin punch tool for fire arms that to free up a fire arm housing pin the fire arm is held with one hand and the other hand pushes the punch into the pin.

Additional objects of the present invention will appear as the description proceeds.

The present invention overcomes the shortcomings of the prior art by providing a pin punch having an ergonomic t-shaped handle which improves the users comfort and controllable use of the device and reduces user fatigue. The pin punch is used to remove housing pins to field strip a firearm. Some firearms require moving a part while pushing on a particular pin until you feel the pin move past a detent

The foregoing and other objects and advantages will appear from the description to follow. In the description reference is made to the accompanying drawing, which forms a part hereof, and in which is shown by way of illustration specific embodiments in which the invention may be practiced. These embodiments will be described in sufficient detail to enable those skilled in the art to practice the invention, and it is to be understood that other embodiments may be utilized and that structural changes may be made without departing from the scope of the invention. In the accompanying drawing, like reference characters designate the same or similar parts throughout the several views.

The following detailed description is, therefore, not to be taken in a limiting sense, and the scope of the present invention is best defined by the appended claims.

### BRIEF DESCRIPTION OF THE DRAWING FIGURES

In order that the invention may be more fully understood, it will now be described, by way of example, with reference to the accompanying drawing in which:

FIG. 1 is an illustrative view of the present invention in use;

FIG. 2 is a frontal view of the present invention;

FIG. 3 is a frontal view of the present invention;

FIG. 4 is a side view of the present invention;

FIG. 5 is a bottom view of the present invention;

FIG. 6 is a sectional view of the present invention;

FIG. 7 is an illustrative view of the present invention;

FIG. 8 is an illustrative view of the present invention removing a housing pin;

FIG. 9 is an illustrative view of the present invention;

FIG. 10 is a front view of the present invention with a lift notch;

FIG. 11 is a detailed view of the lift notch;

FIG. 12 is a partial sectional view of the pin punch of the present invention;

FIG. 13 is a front view of the present invention; and

FIG. 14 is an enlarged end view of the pin punch shaft of the present invention.

### DESCRIPTION OF THE REFERENCED NUMERALS

Turning now descriptively to the drawings, in which similar reference characters denote similar elements throughout the several views, the figures illustrate the Firearm Disassembly Tool of the present invention. With regard to the reference numerals used, the following numbering is used throughout the various drawing figures.
10 Firearm Disassembly Tool of the present invention
12 pin punch
14 T-shaped handle
16 user
18 firearm
20 housing pin
22 shaft
24 shaft notch
26 collar
28 shaft nipple
30 housing pin dimple

### DETAILED DESCRIPTION OF THE PREFERRED EMBODIMENT

The following discussion describes in detail one embodiment of the invention (and several variations of that embodiment). This discussion should not be construed, however, as limiting the invention to those particular embodiments; practitioners skilled in the art will recognize numerous other embodiments as well. For definition of the complete scope of the invention, the reader is directed to appended claims.

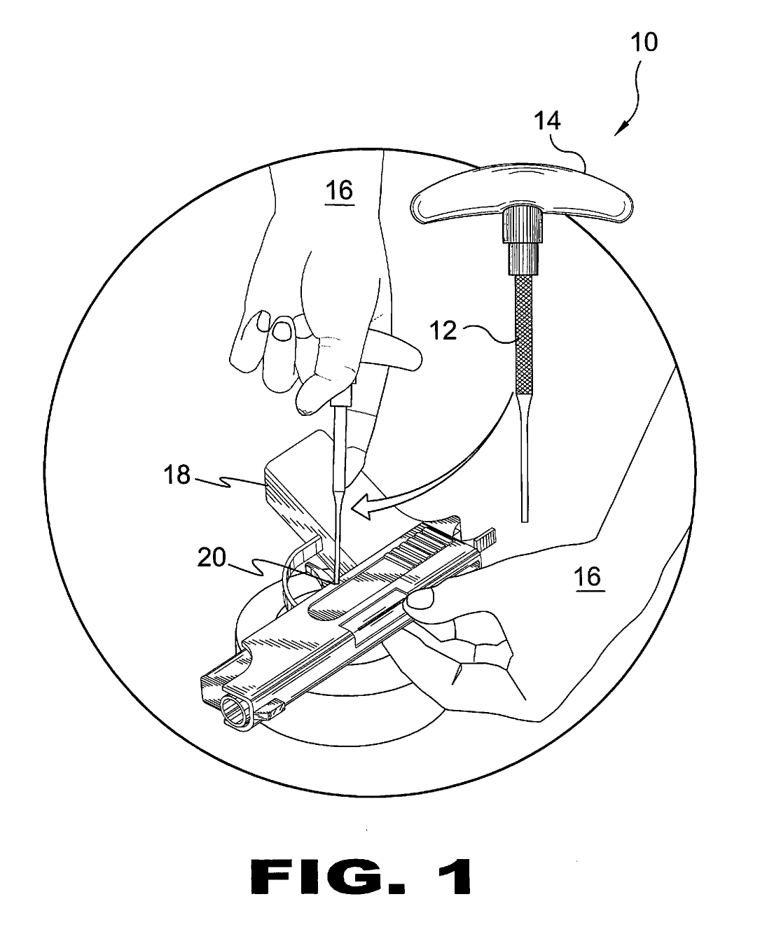

Referring to FIG. 1, shown is an illustrative view of the present invention 10 in use. The present invention 10 is a pin punch 12 having an ergonomic T-shaped handle 14 which improves the users 16 comfort and controllable use of the device and reduces user fatigue. The pin punch 12 is used to remove housing pins 20 to strip a firearm 18. Some firearms 18 require moving a part while pushing on a particular pin 20 until you feel the pin 20 move past a detent.

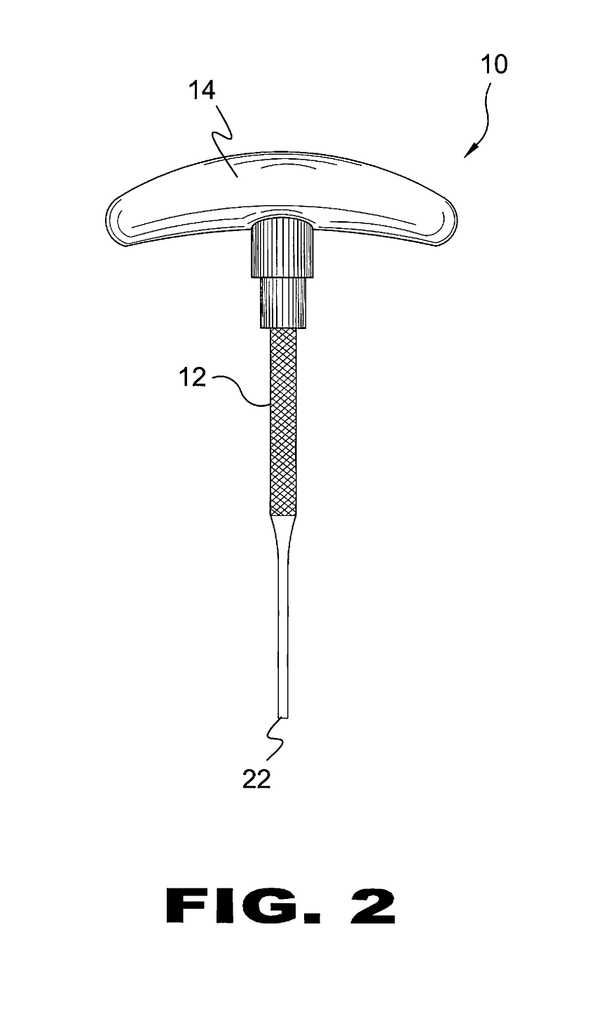

Referring to FIG. 2, shown is a frontal view of the present invention 10. Shown is the pin punch 12 having a T-shaped handle 14 and tapered pin punch shaft 22 used to remove housing pins to field strip a firearm.

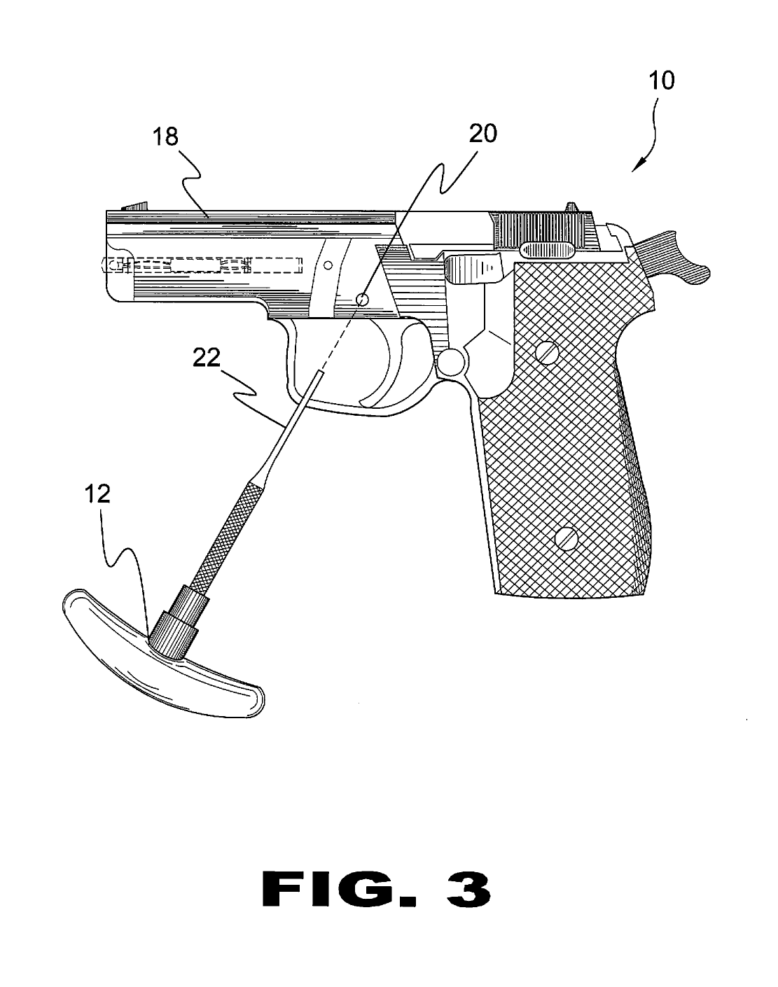

Referring to FIG. 3, shown is a frontal view of the present invention 10. Shown is the shaft 22 of the pin punch 12 about to come in contact with a housing pin 20 on a pistol 18. The tool is used to remove housing pins 20 to strip a firearm 18. The shaft 22 could be of various lengths and thicknesses depending upon the firearm 18.

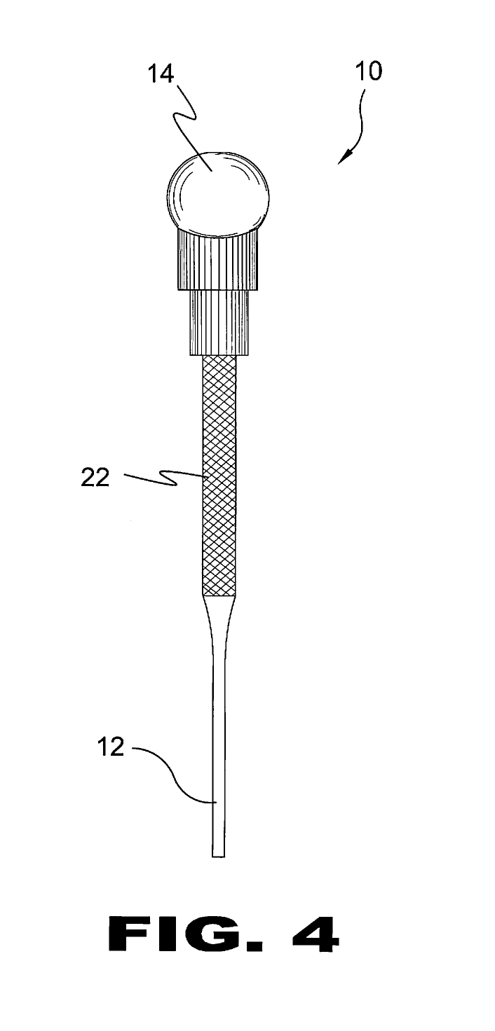

Referring to FIG. 4, shown is a side view of the present invention 10. The pin punch 12 has a T-shaped handle 14 having a shaft 22 used to remove housing pins to field strip a firearm. The T-handle 14 is easier to manipulate and provides greater concentration of force than the screwdriver type handle known in the art.

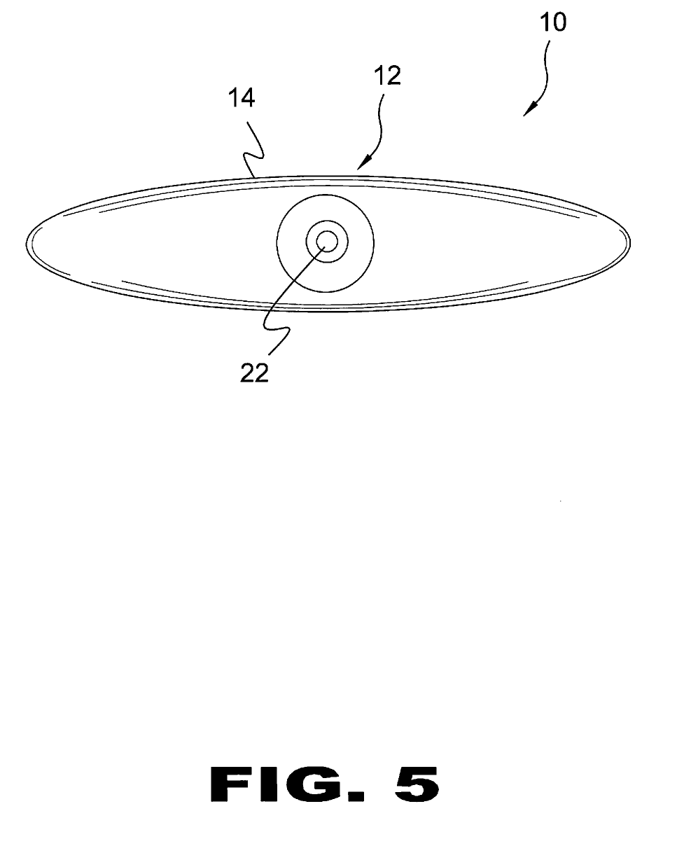

Referring to FIG. 5, shown is a bottom view of the present invention 10. The pin punch 12 provides a T-shaped handle 14 having a shaft 22 used to remove housing pins to field strip a firearm.

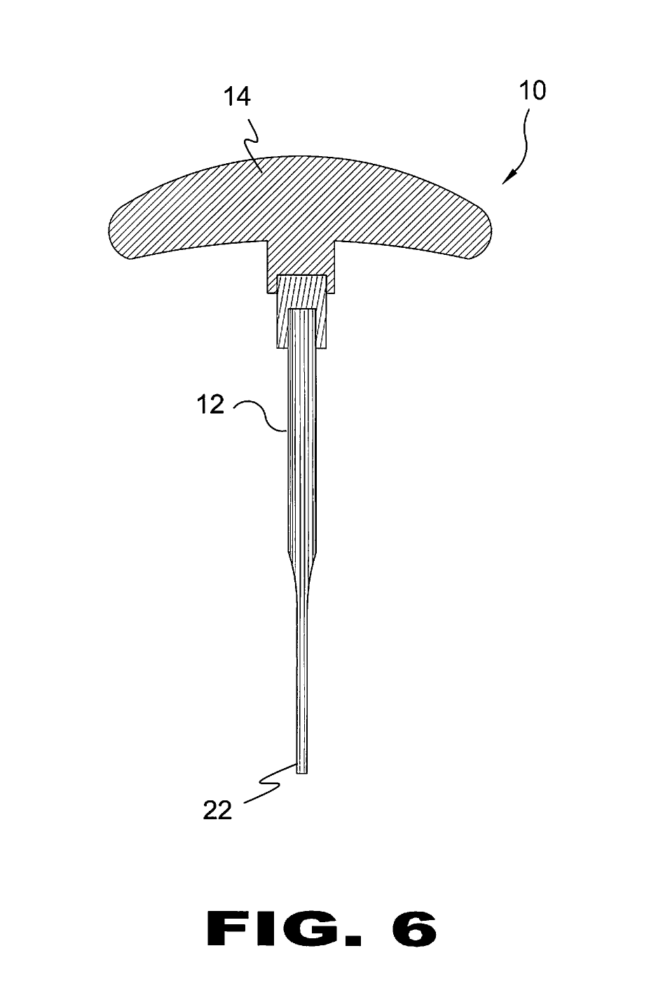

Referring to FIG. 6, shown is a sectional view of the present invention 10. Shown is a sectional view of a pin punch tool 12 having an ergonomic T-shaped handle 14 and tapered shaft 22 extending therefrom. The pin punch tool 12 is used to remove housing pins to field strip a firearm. Some firearms require moving a part while pushing on a particular pin until you feel the pin move past a detent.

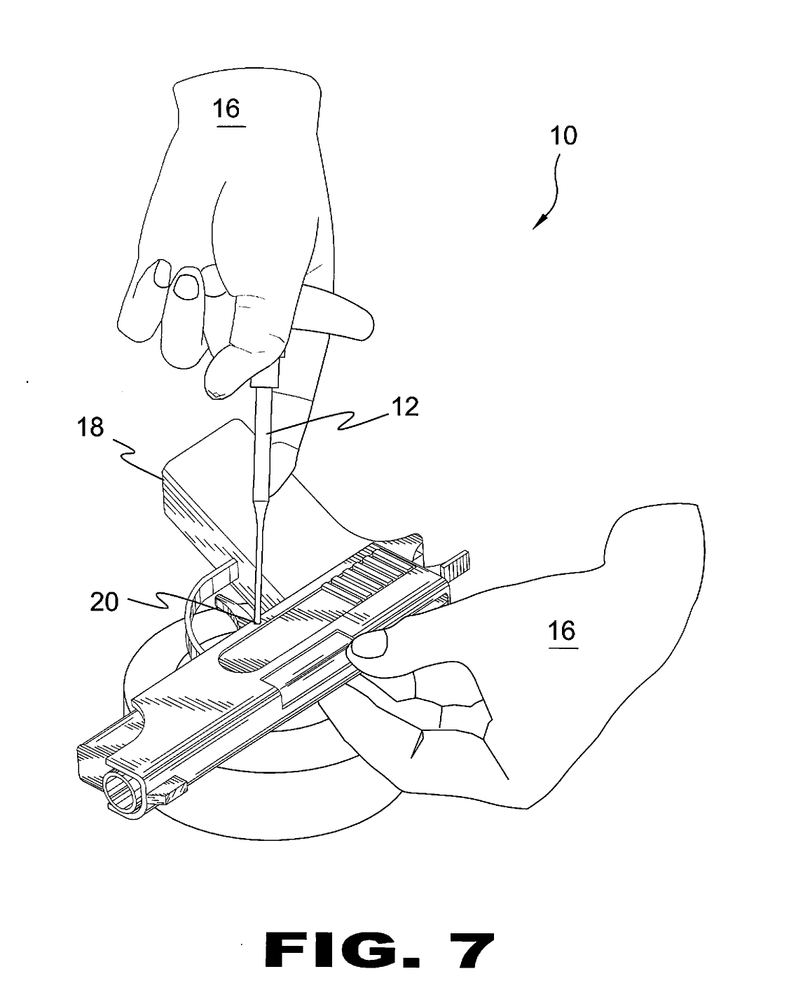

Referring to FIG. 7, shown is an illustrative view of the present invention 10 in use. Shown is the pin punch 12 beginning to push out a housing pin 20 of a pistol 18. The pin punch 12 is used to remove housing pins 20 to field strip a firearm 18. Some firearms 18 require moving a part while pushing on a particular pin until you feel the pin 20 move past a detent. The punch 12 is pushed with one hand 16 and a gun part is moved with the other hand 16, to free up the pin 20 or in other cases, hold the gun with one hand and push with the punch with the other hand.

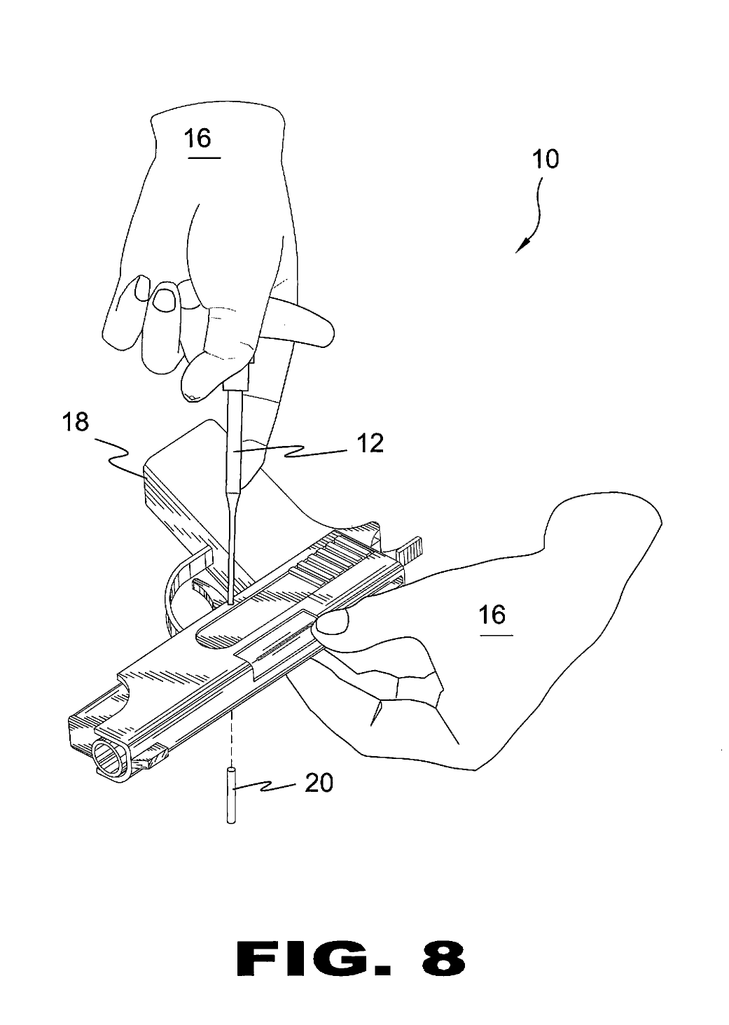

Referring to FIG. 8, shown is an illustrative view of the present invention 10 removing a housing pin 20. Shown is an illustrative view the present invention 10 removing a housing pin 20 of a pistol 18. The pin punch 12 is used to remove housing pins 20 to field strip a firearm 18. Some firearms 18 require moving a part while pushing on a particular pin 18 until you feel it move past a detent.

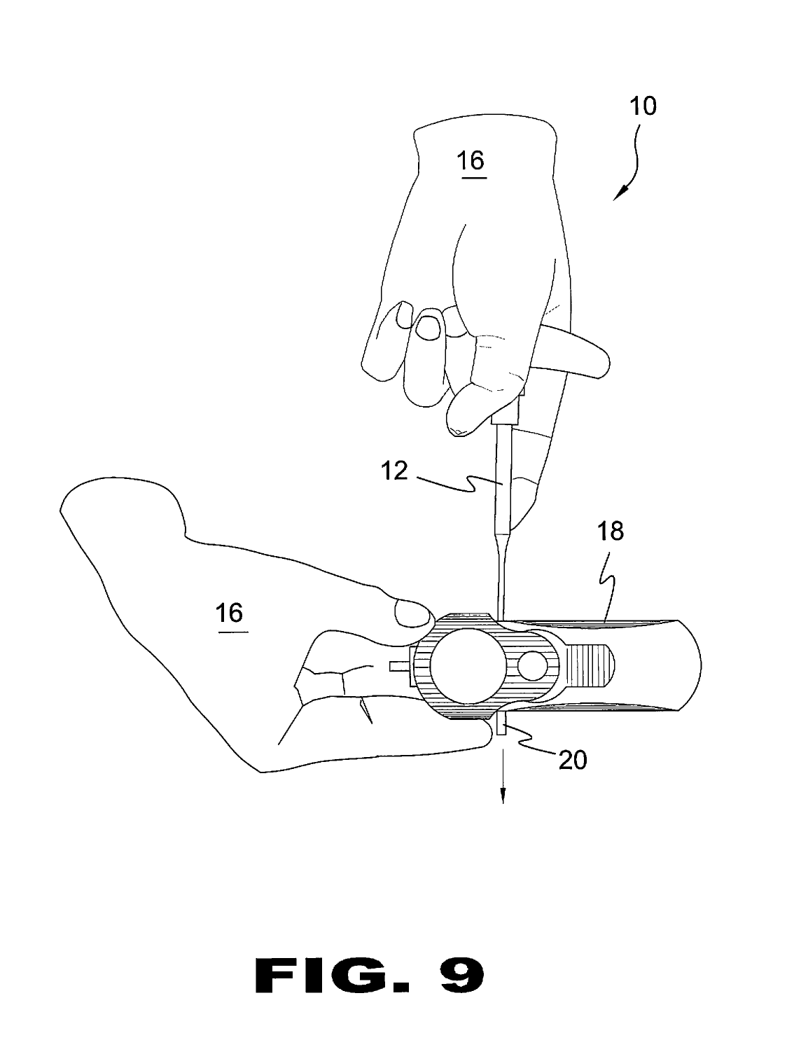

Referring to FIG. 9, shown is an illustrative view of the present invention 10 in use. Shown is the pin punch 12 beginning to push out a housing pin 20 of a pistol 18. The pin punch 12 is used to remove housing pins 20 to field strip a firearm 18. Some firearms 18 require moving a part while pushing on a particular pin until you feel the pin 20 move past a detent. The punch 12 is pushed with one hand 16 and a gun part is moved with the other hand 16, to free up the pin 20 or in other cases, hold the gun with one hand and push with the punch with the other hand.

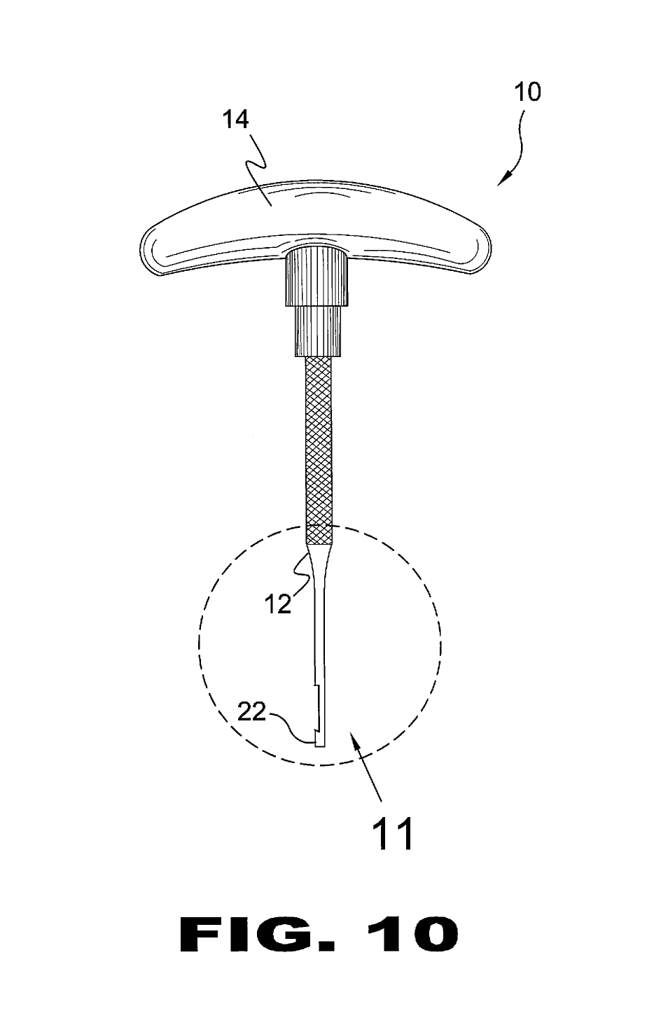

Referring to FIG. 10, shown is a front view of the present invention 10 including a lift notch 24 disposed on the side of the shaft 22 proximal to the punch end. The shaft 22 is also used as a pry bar with other components when stripping a firearm including raising the locking block and releasing the trigger assembly. Said lift notch 24 provides a grabbing element that prevents shaft 22 from slipping while manipulating a component.

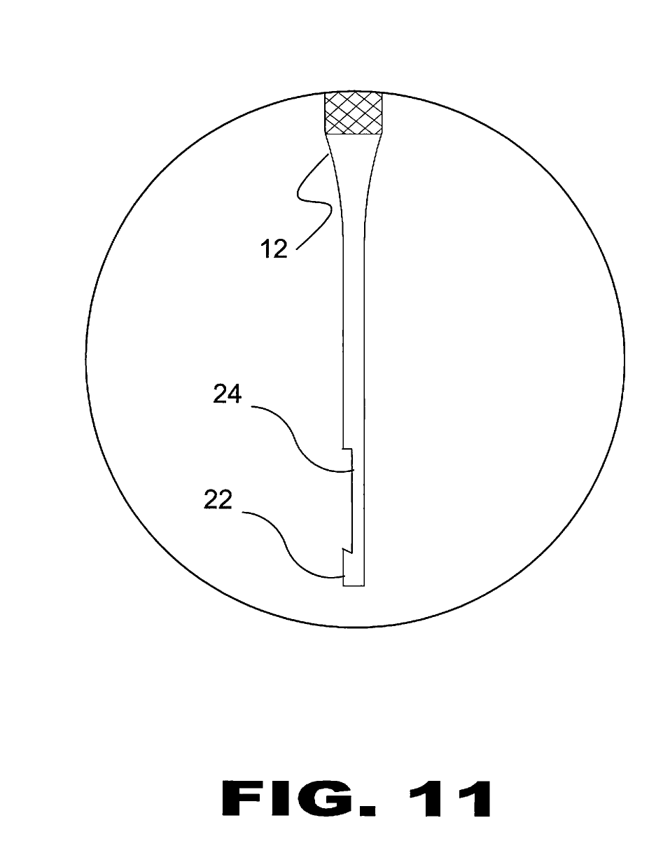

Referring to FIG. 11, shown is a detailed view of the present invention 10 including a lift notch 24 disposed on the side of the shaft 22 proximal to the punch end. The shaft 22 is also used as a pry bar with other components when stripping a firearm including raising the locking block and releasing the trigger assembly. Said lift notch 24 provides a grabbing element that prevents shaft 22 from slipping while manipulating a component.

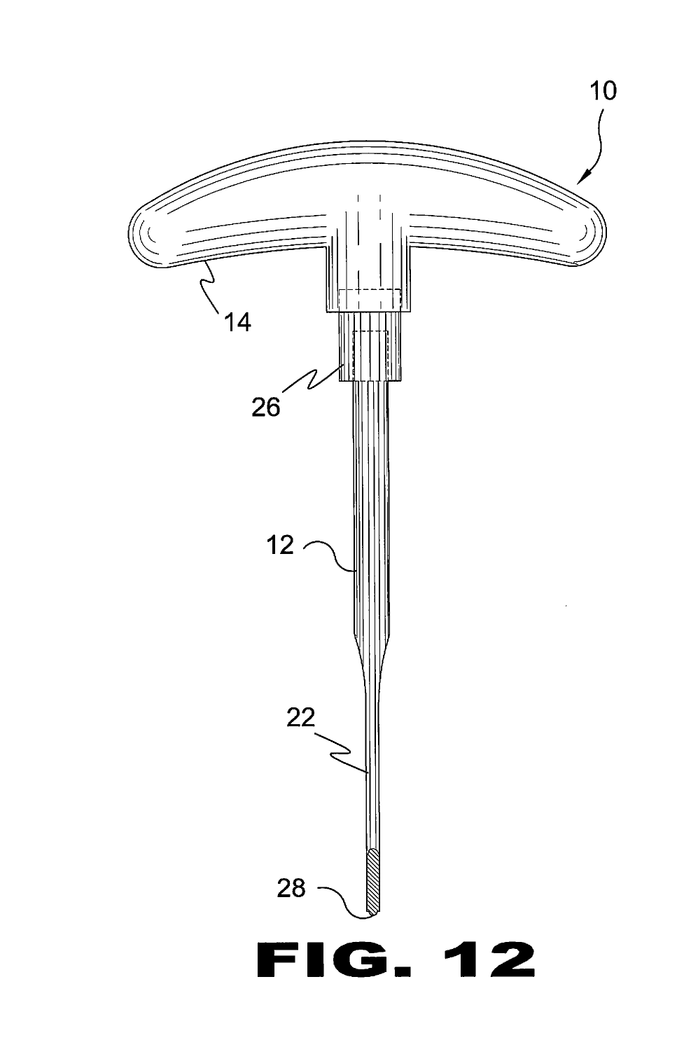

Referring to FIG. 12, shown is a partial sectional view of the pin punch of the present invention 10. Shown is a partial sectional view of a pin punch tool 12 having an ergonomic T-shaped handle 14 with a collar 26 fixed therein and a tapered shaft 22 within said collar 26 and extending therefrom having nipple 28 projecting from the pin punch shaft. The pin punch tool 12 is used to remove housing pins having a dimple 30—to field strip a firearm. Some firearm retaining pins have a dimple on each end of the pin as part of their assembly. These dimples are centered on the ends of each pin and are designed to assist in centering the punch, which is used to remove the pin by pushing the pin through the frame of the gun. The addition of a protrusion or nipple in the center of the punch is the inverse shape to the dimple of the retaining pin in the firearm. This mating of shapes assists in maintaining the punch in the center of the pin while the pin is being pushed out of the firearm frame.

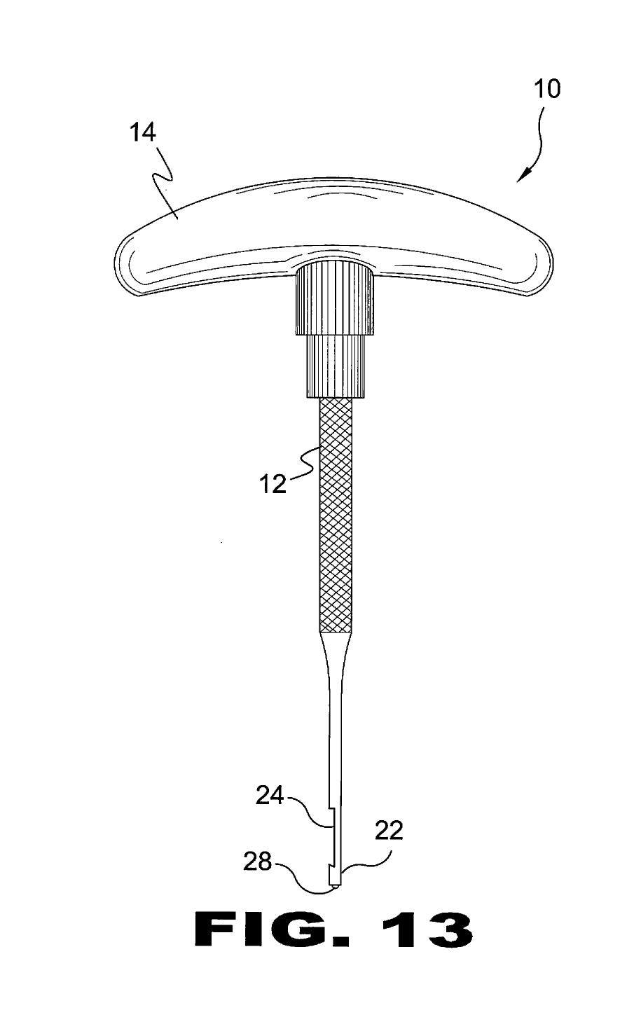

Referring to FIG. 13, shown is a front view of the present invention. Shown is the pin punch tool 12 having an ergonomic T-shaped handle 14 with a collar 26 fixed therein and a tapered shaft 22 within said collar 26 and extending therefrom having nipple 28 projecting from the pin punch including a lift notch 24 disposed on the side of the shaft 22 proximal to the punch end. The shaft 22 is also used as a pry bar with other components when stripping a firearm including raising the locking block and releasing the trigger assembly.

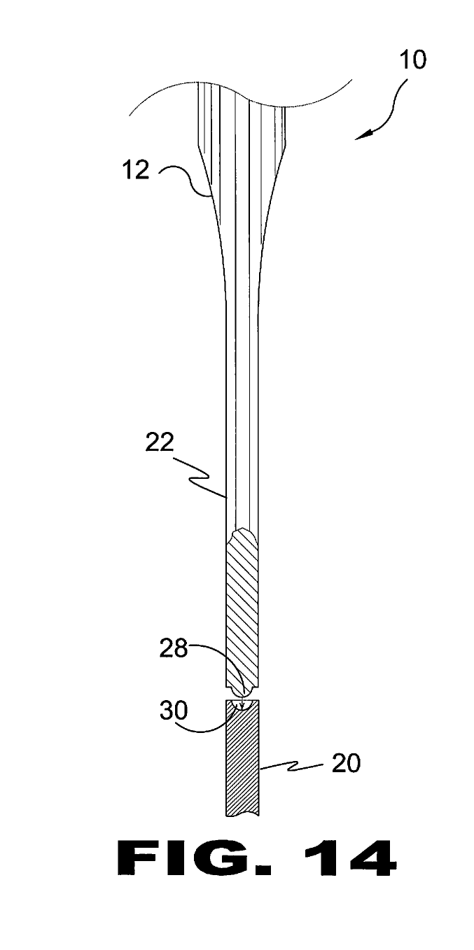

Referring to FIG. 14, shown is an enlarged end view of the pin punch of the present invention 10. Shown is an enlarged view of the pin punch shaft 22 which has an ergonomic T-shaped handle with a collar fixed therein and a tapered shaft 22 within said collar and extending therefrom having nipple 28 projecting from the pin punch shaft. Also shown is housing pin 20 having dimple 30. The pin punch nipple 28 is seated within housing pin 20 dimple 30 whereupon the user applies a force to the tool handle with one hand and a gun part is moved with the other hand, to free up pin 20.

It will be understood that each of the elements described above, or two or more together may also find a useful application in other types of methods differing from the type described above.

While certain novel features of this invention have been shown and described and are pointed out in the annexed claims, it is not intended to be limited to the details above, since it will be understood that various omissions, modifications, substitutions and changes in the forms and details of the device illustrated and in its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention

What is claimed is new and desired to be protected by Letters Patent is set forth in the appended claims:

1. A firearm stripping tool for removing housing pins and moving components comprising:
a) a shaft having a first end and a second end;
b) a T-handle disposed on said first end of said shaft;
c) a pin punch disposed on said second end of said shaft having a circumference less than that of said housing pins.

2. The firearm stripping tool recited in claim 1, wherein said pin punched end of said shaft against a housing pin in direct orientation with said pin and a user-applied bias against said T-handle forces said housing pin through its respective recess in said firearm.

3. The firearm stripping tool recited in claim 2, wherein said T-handle provides greater force and stability when removing a housing pin than the screwdriver-type handle currently used in the art.

4. The firearm stripping tool recited in claim 3, wherein said pin punched end of said shaft is placed on a housing pin in direct orientation with said pin and a user-applied bias against said T-handle presents a force against said housing pin while moving a related firearm component until said housing pin passes beyond a detent and through it's respective recess.

5. The firearm stripping tool recited in claim 4, wherein said shaft further includes a notched portion dispose near the distal end of said shaft.

6. The firearm stripping tool recited in claim 5, wherein said notch is used as a stop element to grab a firearm component when used as a lever or push tool.

7. The firearm stripping tool recited in claim 6, wherein said lifting notch is placed underneath the locking block to raise it by prying it upward.

8. The firearm stripping tool recited in claim 7, wherein the ejector of said firearm is placed within said lift notch to apply pressure under the ejector to raise the entire trigger assembly from the receiver.

9. A firearm stripping tool for removing housing pins and moving components comprising:
a) a shaft having a first end and a second end;
b) a collar having a recess for mounting one end of said shaft therein;
c) a T-handle having a recess for mounting said collar and attached shaft therein; and
d) a pin punch disposed on said second end of said shaft having a circumference less than that of said housing pins.

10. The firearm stripping tool recited in claim 9, further comprising a nub projecting from its second end that matingly engages a housing pin having a dimple whereby when said pin punched end of said shaft is placed against a housing pin in direct orientation with said pin and a user-applied bias against said T-handle forces said housing pin through its respective recess in said firearm.

11. The firearm stripping tool recited in claim 10, wherein said shaft further includes a notched portion dispose near the distal end of said shaft.

12. The firearm stripping tool recited in claim 11, wherein said notch portion is used as a stop element to grab a firearm component when used as a lever or push tool.
